(19) United States
(12) Patent Application Publication
(10) Pub. No.: US 2026/0237044 A1
(43) Pub. Date: Aug. 13, 2026

(54) STRUCTURAL FIDELITY INDEX FOR TONE MAPPED VIDEOS

(71) Applicant: IMAX CORPORATION, Mississauga, Ontario (CA)

(72) Inventors: Hojatollah YEGANEH, Waterloo, Ontario (CA); Zhou WANG, Waterloo, Ontario (CA); Armin Shafiee SARVESTANI, Kitchener, Ontario (CA)

(73) Assignee: IMAX CORPORATION, Mississauga, Ontario (CA)

(21) Appl. No.: 19/507,174

(22) PCT Filed: Jul. 31, 2024
(86) PCT No.: PCT/IB2024/057439

§ 371 Date: Jan. 30, 2026

Related U.S. Application Data
(60) Provisional application No. 63/516,875, filed on Aug. 1, 2023.

(51) Int. Cl. G06T 7/00; G06T 5/92

(52) U.S. Cl. CPC G06T 7/0002; G06T 5/92; G06T 2207/10016; G06T 2207/20208; G06T 2207/30168

(57) ABSTRACT

An original high dynamic range (HDR) video having a first range of intensity levels and a test HDR video having a second range of intensity levels may be received, where the second range of intensity levels being less than the first range of intensity levels. A measure of structural fidelity of one or more test frames of the test HDR video is computed compared to a corresponding one or more original frames of the original HDR video using a combination of a plurality of per-scale structural fidelity maps, the structural fidelity being computed using a contrast sensitivity function based on operation of the human visual system. A HDR video structural fidelity score is determined based on the measure of structural fidelity of the one or more frames of the test HDR video.

### CROSS-REFERENCE TO RELATED APPLICATIONS

This application claims the benefit of U.S. provisional application Ser. No. 63/516,875 filed Aug. 1, 2023, the disclosure of which is hereby incorporated in its entirety by reference herein.

### TECHNICAL FIELD

Aspects of the disclosure relate to a structural fidelity index for use with high dynamic range (HDR) tone-mapped video.

### BACKGROUND

There is growing interest in HDR images, where the range of intensity levels is on the order of 10,000:1 or even 100,000:1. This range allows for accurate representations of the luminance variations in real scenes, varying from direct sunlight to faint starlight. With continuing advances in imaging and computer graphics technologies, HDR video is becoming more widely available.

### SUMMARY

In one or more illustrative examples, a method for computing a video quality index for reduced dynamic range HDR video is provided. The method includes receiving an original HDR video having a first range of intensity levels and a test HDR video having a second range of intensity levels, the second range of intensity levels being less than the first range of intensity levels. The method also includes computing a measure of structural fidelity of one or more test frames of the test HDR video compared to a corresponding one or more original frames of the original HDR video using a combination of a plurality of per-scale structural fidelity maps, the structural fidelity being computed using a contrast sensitivity function (CSF) based on operation of the human visual system; and the method also includes determining a HDR video structural fidelity score based on the measure of structural fidelity of the one or more frames of the test HDR video.

In one or more illustrative examples, a system for computing a video quality index for reduced dynamic range HDR video includes one or more computing devices, programmed to receive an original HDR video having a first range of intensity levels and a test HDR video having a second range of intensity levels, the second range of intensity levels being less than the first range of intensity levels; compute a measure of structural fidelity of one or more test frames of the test HDR video compared to a corresponding one or more original frames of the original HDR video using a combination of a plurality of per-scale structural fidelity maps, the structural fidelity being computed using a contrast sensitivity function based on operation of the human visual system; and determine a HDR video structural fidelity score based on the measure of structural fidelity of the one or more frames of the test HDR video.

In one or more illustrative examples, a non-transitory computer-readable medium includes instructions for computing a video quality index for reduced dynamic range HDR video that, when executed by one or more computing devices, cause the one or more computing devices to perform operations including to receive an original HDR video having a first range of intensity levels and a test HDR video having a second range of intensity levels, the second range of intensity levels being less than the first range of intensity levels; compute a measure of structural fidelity of one or more test frames of the test HDR video compared to a corresponding one or more original frames of the original HDR video using a combination of a plurality of per-scale structural fidelity maps, the structural fidelity being computed using a contrast sensitivity function based on operation of the human visual system; and determine a HDR video structural fidelity score based on the measure of structural fidelity of the one or more frames of the test HDR video.

### BRIEF DESCRIPTION OF THE DRAWINGS

FIG. 1A illustrates an example framework for a structural fidelity assessment for determining a video quality index of HDR video of reduced dynamic range;

FIG. 1B illustrates an example detail of the framework for the determination of the per-frame structural fidelity measure S;

FIG. 1C illustrates an example combination of the structural fidelity determination discussed in FIGS. 1A-1B with a statistical naturalness determination;

FIG. 1D illustrates an example of a method flow chart for determination of the per-scale structural fidelity score (S1, S2 . . . );

FIG. 2A illustrates a histogram of means of gray-scale images that represent many different types of natural scenes fitted by a Gaussian probability distribution function (PDF);

FIG. 2B illustrates a histogram of standard deviations of the gray-scale images fitted by a Beta PDF;

FIG. 3A illustrates an example of a first tone mapped image and a set of per-scale structural fidelity maps computed at 250 nits of test target luminance;

FIG. 3B illustrates an example of the first tone mapped image and a set of per-scale structural fidelity maps computed at 500 nits of test target luminance;

FIG. 3C illustrates an example of the first tone mapped image and a set of per-scale structural fidelity maps computed at 1000 nits of test target luminance;

FIG. 4A illustrates an example of a second tone mapped image and a set of per-scale structural fidelity maps computed at 250 nits of test target luminance;

FIG. 4B illustrates an example of the second tone mapped image and a set of per-scale structural fidelity maps computed at 500 nits of test target luminance;

FIG. 4C illustrates an example of the second tone mapped image and a set of per-scale structural fidelity maps computed at 1000 nits of test target luminance;

FIG. 5A illustrates an example of a third tone mapped image and a set of per-scale structural fidelity maps computed at 250 nits of test target luminance;

FIG. 5B illustrates an example of the third tone mapped image and a set of per-scale structural fidelity maps computed at 500 nits of test target luminance;

FIG. 5C illustrates an example of the third tone mapped image and a set of per-scale structural fidelity maps computed at 1000 nits of test target luminance;

FIG. 6A illustrates an example of a fourth tone mapped image and a set of per-scale structural fidelity maps computed at 250 nits of test target luminance;

FIG. 6B illustrates an example of the fourth tone mapped image and a set of per-scale structural fidelity maps computed at 500 nits of test target luminance;

FIG. 6C illustrates an example of the fourth tone mapped image and a set of per-scale structural fidelity maps computed at 1000 nits of test target luminance;

FIG. 7 illustrates an example process for performing a structural fidelity analysis of reduced HDR video;

FIG. 8 illustrates an example process for performing a combined structural fidelity and statistical naturalness analysis of reduced HDR video; and

FIG. 9 illustrates an example of a computing device for use in performing the operations discussed in detail herein.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Tone-mapping operators (TMOs) are tools that convert HDR images to images of lower dynamic range. In an example, TMOs are used for the visualization of HDR video on physical screens. This is because many screens have lower dynamic range than that of the HDR source content. There has been an increasing number of TMOs developed in recent years, with differing levels of performance.

Aspects of the disclosure relate to an objective video quality assessment (VQA) model for analyzing HDR video that is processed by a TMO. The VQA model may be performed using the corresponding original HDR video as a reference. Such a VQA may be useful, for example, in assessing the structural detail loss on an HDR display when watching HDR content.

Different TMOs may create different tone-mapped video results. Because of the reduction in dynamic range, tone mapping procedures inevitably cause information loss. Yet, it may be difficult to measure which TMO generates a tone-mapped output of the best quality. With multiple TMOs available, it may be desirable to be able to measure which TMO faithfully preserves the structural information in the original HDR images. Without an appropriate quality measure, different TMOs cannot be compared. Subjective rating may be a reliable evaluation method, but it is expensive and time consuming, and more importantly, is difficult to be embedded into optimization frameworks.

Some objective quality assessment approaches assume that frames of the reference and test video to have the same dynamic range, and thus cannot be directly applied to evaluate tone mapped images. For example, the HDR visible differences predictor (HDR-VDP) is a human visual system (HVS) based fidelity metric that aims to distinguish between visible (suprathreshold) and invisible (subthreshold) distortions. The metric reflects the perception of distortions in terms of detection probability. Yet, as HDR-VDP is designed to predict the visibility of differences between two HDR frames of the same dynamic range, it is not applicable to compare an original HDR video with a reduced version of the HDR video having a lower dynamic range.

Although HDR refers to High Dynamic Range, the methods disclosed within that refer to HDR can also be applied to formats with a different dynamic range designation such as standard dynamic range (SDR) or to formats with a different dynamic range designation. The methods are not specific to a particular dynamic range but can be applied to formats of any dynamic range that is different.

A dynamic range independent approach may improve upon HDR-VDP and produce quality maps that indicate the loss of visible features, the amplification of invisible features, and reversal of contrast polarity, respectively. These quality maps show good correlations with subjective classifications of image degradation types including blur, sharpening, contrast reversal, and no distortion. However, such approaches may not provide a single quality score for an entire video, making it difficult to be validated with subjective evaluations of overall video quality.

Due to the reduction in dynamic range, TMOs cannot preserve all information in HDR video, and human observers of the reduced dynamic range versions of the video may not be aware of this. Therefore, structural fidelity plays an important role in assessing the quality of tone-mapped images.

An improved VQA is disclosed herein that uses structural fidelity to determine a quality measure for comparing an original HDR video to a processed HDR video of reduced dynamic range. The VQA includes various enhancements to improve the quality of the metric when used on HDR video sources of differing dynamic range. For instance, because the luminance and bit depth of the source frame is often different from the luminance and bit depth of the test frame, thresholds for signal standard deviation should be considered separately for the source vs the test image. In addition, selecting a high-quality contrast sensitivity function (CSF) that reflects the human visual system also improves performance.

In some examples, the structural fidelity VQA may be enhanced with a further consideration of statistical naturalness. This may allow the VQA to additionally measure whether the HDR video of reduced dynamic range maintains a good compromise between structural fidelity preservation and statistical naturalness, which are sometimes competing factors. Further aspects of the improved VQA are discussed in detail herein.

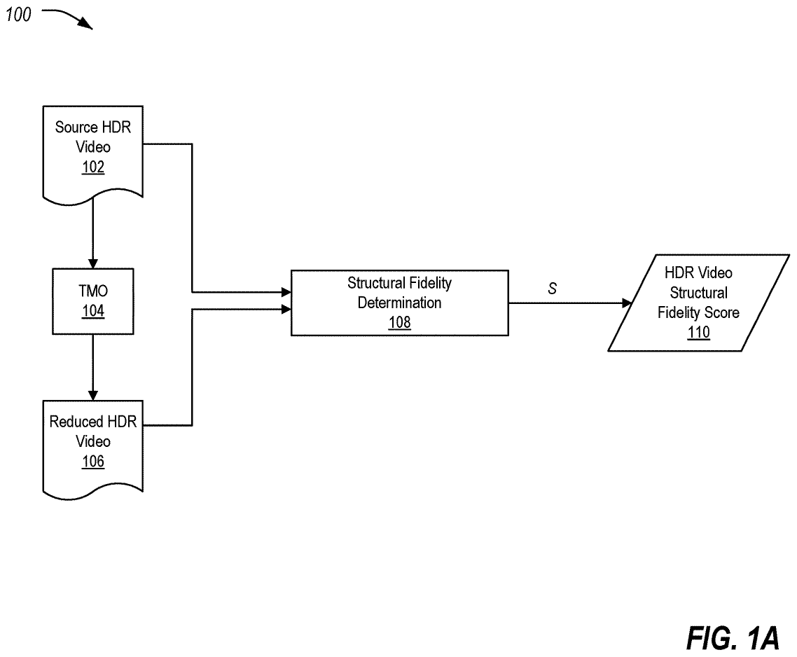

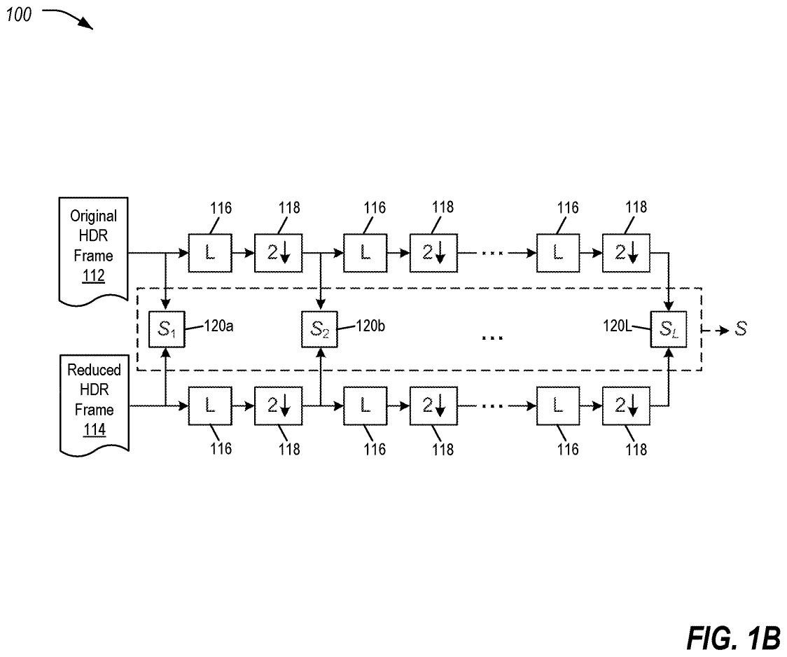

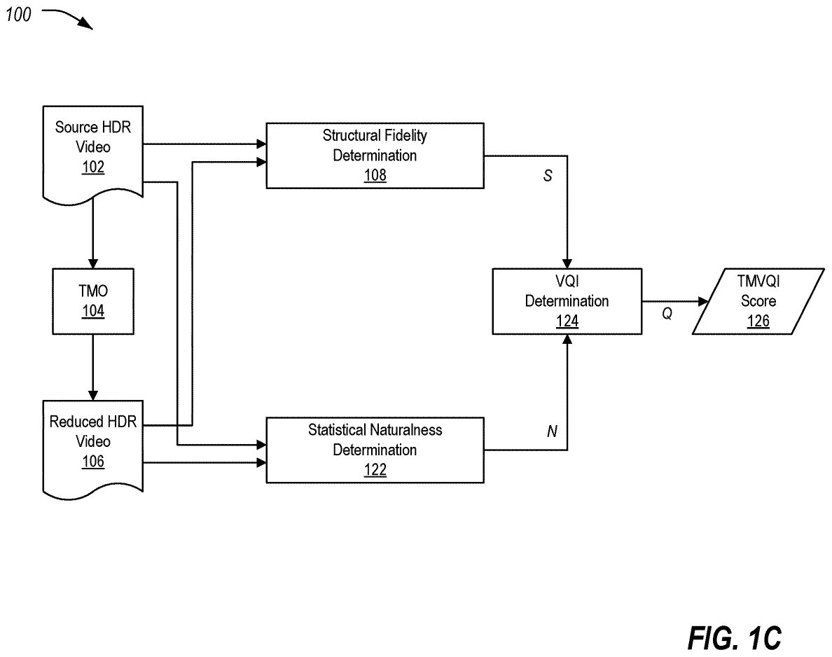

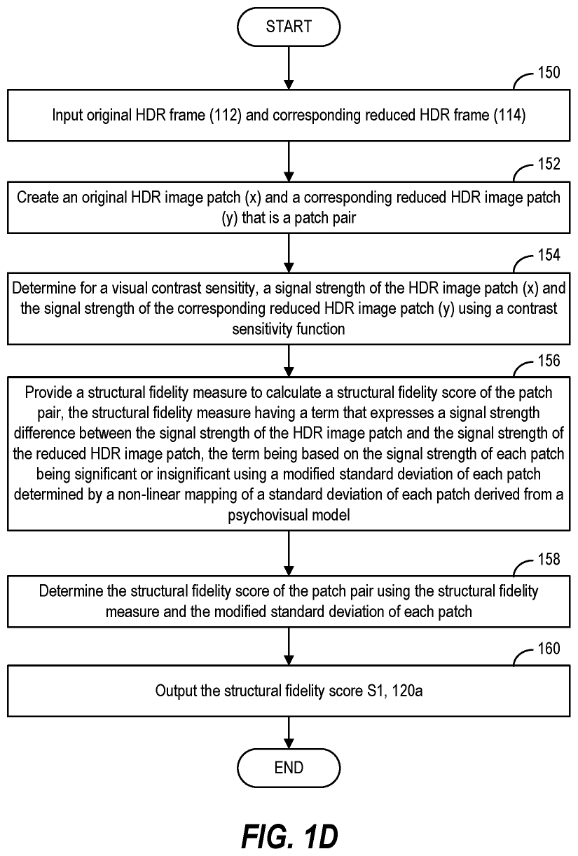

FIG. 1A illustrates an example framework 100 for a structural fidelity assessment for determining a video quality index of HDR video of reduced dynamic range. As shown, an original HDR video 102 is received. A TMO 104 converts the original HDR video 102 into a test HDR video 106 having less dynamic range than the original HDR video 102. A structural fidelity determination 108 is performed on the test HDR video 106 based on the original HDR video 102. A HDR video structural fidelity score 110 is determined based on the results of the structural fidelity determination 108.

As used herein, the original HDR video 102 refers to video content that is received to the TMO 104 for processing. For instance, the original HDR video 102 may be received to a TMO 104 of a display device to reduce the dynamic range of the original HDR video 102 for output by the panel of the display device. The video content may include, as some examples, live video feeds from current events, prerecorded shows or movies, and advertisements or other clips to be inserted into other video feeds. The video content may include just video in some examples, but in many cases the video further includes additional content such as audio, subtitles, and metadata information descriptive of the content and/or format of the video.

The original HDR video 102 may be encoded in various ways. For example, the original HDR video 102 may be encoded in a format that allows pixel values to span a large tonal range corresponding to real-world scenes. This range of values may involve ratios on the order of 10,000:1 or even 100,000:1. As a possibility, the original HDR video 102 may be encoded in a format having floating-point values stored with 32 bits per color channel (i.e. 96 bits per pixel for a color image). In another example, the ITU-R BT.2100 international standard for HDR establishes aspects of the encoding of HDR content at various resolutions, such as HD, 4K, and 8K, with bit depths such as 10-12 bits. Rec. 2100 specifies for the original HDR video 102 to be delivered with wide color gamuts (WCG) to allow for the encoding and reproduction of up to approximately 75% of the colors that may be discernible by the human visual system (HVS). In yet another example, the HDR content may take the form of a 16-bit TIFF file, e.g., as converted from a RAW file captured by an image sensor of a camera.

The TMO 104 may be configured to transform the original HDR video 102 into a perceptually similar but lower-dynamic-range test HDR video 106. Mapping the dynamic range of original HDR video 102 into the test HDR video 106 may be required because many imaging devices are only able to display images within a smaller dynamic range, on the order of 1000:1. Some TMOs 104 apply the same pixel-wise adjustment to all pixels in a frame of the original HDR video 102, while other TMOs 104 define an algorithm that applies a combination of pixel-wise processing and spatial transformations to improve the resultant test HDR video 106.

The structural similarity index measure (SSIM) approach provides a useful design philosophy as well as a practical method for measuring structural fidelities between images. Early SSIM algorithms can contain different terms where each term is used for a different comparison components. For example, a three term SSIM comparison can be written as follows:

$$SSIM ( x , y ) = [ l ( x , y ) ] \times [ c ( x , y ) ] \times [ s ( x , y ) ] \qquad ( A )$$

in which the comparison terms are luminance, contrast and structure between patch x and patch y where x and y are two corresponding image patches (image areas) being compared. The luminance term, l(x,y) compares the brightness of corresponding images, the contrast term, c(x,y), compares the variances of corresponding images, and the structure term, s(x,y), compares the structure of corresponding images by normalizing the covariance.

A patch can refer to a portion of an image frame or an image frame or a group of image frames. A portion of an image frame can be a localized area of interest of an image frame. The SSIM measure can be applied locally to corresponding portions of an image, or to the whole area of corresponding image frames, or to a collective sum of corresponding areas of a group of image frames.

Since TMOs 104 are meant to change local intensity and contrast of an image, direct comparisons of local intensity and contrast between corresponding images are inappropriate when comparing an HDR frame with a corresponding reduced HDR frame where luminance and contrast are inherently different as opposed to unintentionally different as in other situations (e.g., when the test signal is not a reduced HDR signal). Multiple subjective studies on tone-mapped HDR videos (i.e., reduced HDR videos) displayed on screens with limited peak luminance have shown that the human visual system is susceptible to the loss of structural details. Additionally, it became evident that it is useful to consider the impact of both content luminance and display luminance on the human visual system when determining the visibility of signal contrast.

Therefore, an alternate local structural fidelity measure may be utilized needed. Such a SSIM measure can be of the form:

$$SSIM ( x , y ) = [ [ c s ( x , y ) ] \times [ s ( x , y ) ] \qquad ( B )$$

Here the luminance term l(x,y) and the contrast term c(x,y), are omitted, as they are not applicable for cross-dynamic range comparison as these comparison terms are not intended for quality or fidelity assessment tasks involving cross-dynamic ranges (differences resulting from patch x and y having different dynamic range). A term cs(x,y) has been added representing a visible contrast sensitivity better suited at indicating quality involving patches with cross-dynamic ranges. The structure comparison term s(x,y), can remain the same. Here x can be a patch extracted from the original HDR video 102 and y can be a corresponding patch that is a reduced HDR image patch from the lower dynamic range test HDR video 106.

A structural fidelity measure that is local to a corresponding patch pair may therefore be defined as:

$${S}_{l o c a l} ( x , y ) = \frac{2 {σ}_{x}^{′} {σ}_{y}^{′} + {C}_{1}}{{σ}_{x}^{′2} + {σ}_{y}^{′2} + {C}_{1}} \cdot \frac{{σ}_{xy} + {C}_{2}}{{σ}_{x} {σ}_{y} + {C}_{2}} \qquad ( 1 )$$

where:
σₓ, σ_{y}, and σ_{xy} are the standard deviations and cross correlation between the two corresponding image patches in the original HDR video 102 and the test HDR video 106, respectively, and
C₁ and C₂ are positive stabilizing constants.

The structural fidelity measure in equation (1) accordingly includes two terms: (a) visible contrast sensitivity signal strength difference term

$$\frac{2 {σ}_{x}^{′} {σ}_{y}^{′} + {C}_{1}}{{σ}_{x}^{′2} + {σ}_{y}^{′2} + {C}_{1}}$$

and (b) a structural comparison term

$$\frac{{σ}_{x y} + {C}_{2}}{{σ}_{x} {σ}_{y} + {C}_{2}} .$$

In one example corresponding frames of the original HDR video 102 and the test HDR video 106 may be applied to a structural fidelity determination 108 block to determine term (a) of the equation (1), the result of which can be a score for a corresponding frame pair, the score referred to herein as S. The corresponding frame pair being a patch pair that is a single frame of the original HDR video and the corresponding single frame of the reduced HDR test video. Or, the determination of a score S may be performed across multiple corresponding frame pairs frames of the original HDR video 102 and the test HDR video 106 to provide a measure of S over a sequence of frames in time period. This measure of S is shown in FIG. 1A as the HDR video structural fidelity score 110. The HDR video structural fidelity score 110 may be computed as an average of S over a plurality of corresponding frame pairs of the original HDR video 102 vs the test HDR video 106.

FIG. 1B illustrates an example detail of the framework 100 for the determination of the structural fidelity measure S for a corresponding frame pair using a multi-scale approach. To perform the processing in a multi-scale approach, an original HDR frame 112 of the original HDR video 102 and a corresponding reduced HDR frame 114 of the test HDR video 106 are iteratively passed through low-pass filters 116 and downsamplers 118 to create an image pyramid structure of scores from different scale levels. Per-scale structural fidelity maps are created at each of these scale levels of the pyramid structure, the maps comprising per-scale structural fidelity scores of all the corresponding patch pairs at each scale level. All the scores at a scale level can be combined to produce an overall structural fidelity measure score for the scale level (i.e., 120a, 120b, 120L). A multi-scale structural fidelity score, S, can be generated from the collection of calculated per-scale structural fidelity scores 120a, 120b, . . . 120L.

FIG. 1D illustrates the steps to configure and determine the per scale structural fidelity score such as 120a at the first scale level in FIG. 1B. In block 150 the original HDR frame 112 and the corresponding reduced HDR frame 114 are provided as input to the per-scale structural fidelity score process. Next in block 152, create from the original HDR frame a HDR image patch (x) and from the corresponding reduced HDR frame a corresponding reduced HDR patch (y) that is a patch pair. Patches can be determined based on image areas with image content that has or tends to have a greater influence on the structural fidelity score. The HDR image patch and the corresponding reduced HDR patch from block 152 is used in block 154 to determine for a visual contrast sensitivity, a signal strength of the HDR image patch and the signal strength of the corresponding reduced HDR image patch using a contrast sensitivity function. There are several different contrast sensitivity functions that can be utilized. For example using the CSF based on Barten's model of the contrast sensitivity of the human eye. Other CSFs that could be used can be based on Kelly's model or Watson and Ahumada's model, or Mannos and Sakrison's model, or Peli's CSF model, or Santos-Victor's CSF model or Legge and Foleys model. There are other known CSF not disclosed here that may also be used.

Block 156 represents providing a structural fidelity measure to calculate (compute) a structural fidelity score of the patch pair, the structural fidelity measure having a term that expresses a signal strength difference between the signal strength of the HDR image patch and the signal strength of the reduced HDR image patch. The term is based on the signal strength of each patch being significant (emphasizing an increased probability of being above a visibility threshold) or insignificant (emphasizing an increased probability of being below a visibility threshold) using a modified standard deviation of each patch determined by a non-linear mapping of a standard deviation of each patch derived from a psychovisual model

Block 158 is determining the structural fidelity score of the patch pair using the structural fidelity measure and the modified standard deviation provided from block 156 and outputting the resultant score 120a, block 160. Subsequent per scale structural fidelity scores are determined similarly after each stage of low-pass filtering and downsampling in the image pyramid structure.

There are different ways to express the term in block 156 such that the visible contrast sensitivity signal strength difference term (a) can be configured to factor in two considerations. For example, a first consideration can be the difference of signal strength between the original HDR frame 112 and corresponding reduced HDR frame 114 should not penalize the term when their signal strengths are both significant or both insignificant. A second consideration can be to penalize the term when the signal strength is significant in the original HDR frame and insignificant in the corresponding reduced HDR frame or insignificant in the original HDR frame and significant in the corresponding reduced HDR frame. For example, the visible contrast sensitivity signal strength difference term in equation 1 as shown takes the two above considerations into account to factor in significant and insignificant signal strength. The earlier SSIM measures have terms configured such that any change in signal strength between corresponding frame pairs resulted in the term being penalized and are not based on significant and insignificant signal strength derived from a non-linear mapping.

To distinguish between significant and insignificant signal strength, the standard deviation σ determined from a psychovisual model is passed through a nonlinear mapping, which results in a modified standard deviation σ′ value employed in the visible contrast sensitivity signal strength difference term in equation (1). The nonlinear mapping should be designed so that significant signal strength is mapped towards 1 and insignificant signal strength towards 0, with a smooth transition in-between. Therefore, the nonlinear mapping is related to the visual sensitivity of contrast. Practically, the visual psychophysics of HVS does not have a fixed threshold of contrast detection, but typically follows a gradual increasing probability in observing contrast variations. Psychometric functions describing the detection probability of signal strength have been employed to model the data taken from psychophysical experiments. Generally, the psychometric function resembles a sigmoid shape and the sensory threshold is usually defined at the level of 50% of detection probability.

A commonly adopted psychometric function known as Galton's ogive may be employed to distinguish between significant and insignificant signal strength. Other psychometric functions that can be used are the Weibull Function, or the Logistics Function, or the Gumbel (Extreme Value) Function or the Probit Function. Galton's ogive function takes the form of a cumulative normal distribution function given by:

$$p ( s ) = \frac{1}{\sqrt{2 π} {θ}_{s}} {\int }_{- ∞}^{s} exp [ - \frac{{( s - {τ}_{s} )}^{2}}{2 {θ}_{s}^{2}} ] d x \qquad ( 2 )$$

where:
p is the detection probability density,
s is the amplitude of the sinusoidal stimulus,
τₛ is the modulation threshold, and
θₛ is the standard deviation of the normal distribution that controls the slope of detection probability variation.

Sometimes referred to as Crozier's law, the following ratio is roughly a constant:

$$k = \frac{{τ}_{s}}{{θ}_{s}} \qquad ( 3 )$$

Typical values of k range between 2.3 and 4, and k=3 makes the probability of false alarm considerably small.

A reciprocal of the modulation threshold τₛ is often used to quantify visual contrast sensitivity. This function of spatial frequency is referred to herein as a CSF. Visual contrast refers to a difference in luminance or color that allows a human to distinguish an object. Contrast may be determined by such differences in color and/or in brightness, with the intuition that the human visual system is more sensitive to contrast than to absolute luminance.

For purposes of considering structural fidelity, a simplified version of the Barten's CSF may be used. The Barten model is based on a relation that at the perception threshold, a modulation at an angular spatial frequency of an object being observed, filtered by the total modulation transfer function of the eye-brain system, must overcome the total noise level at the same frequency by a suitable factor, represented by a signal-to-noise ratio. Barten's CSF considers factors such as neural noise, lateral inhibition, photon noise, external noise, limited integration capability, the optical modulation transfer function, orientation, and temporal filtering. Such an approach offers better results than simpler CSF approaches. A simplified Barten's CSF may be expressed as follows:

$$S ( u ) = \frac{5200 {e}^{- 0 \text{.0016} {{u}^{2} ( 1 + \frac{100}{L} )}^{0.08}}}{\sqrt{( 1 + \frac{144}{{X}_{o}^{2}} + 0 \text{.64} {U}^{2} ) ( \frac{63}{{L}^{0.83}} + \frac{1}{1 - {e}^{- 0.02 {u}^{2}}} )}} \qquad ( 4 )$$

where:
S(u) is the contrast sensitivity,
u is the spatial frequency in cycles/degree,
L is the luminance of the object in nits

$$( \frac{cd}{{m}^{2}} ) ,$$

and
Xₒ is the angular size of the object in degrees.

To take into account the surrounding luminance, a correction factor f is defined, by which the CSF has to be multiplied, as follows:

$$f = {e}^{- \frac{{ln}^{2} ( \frac{{L}_{s}}{L} {( 1 + \frac{144}{{X}_{o}^{2}} )}^{0.25} ) - {ln}^{2} ( {( 1 + \frac{144}{{X}_{o}^{2}} )}^{0.25} )}{2 {ln}^{2} ( 32 )}} \qquad ( 5 )$$

where:
L is the luminance of the object in nits,
Xₒ is the angular size of the object in degrees, and
L_{S} is the surrounding luminance in nits

$$( \frac{cd}{{m}^{2}} ) .$$

Note that when L=Lₛ, the factor f=1 and the surrounding luminance is ignored.

Based on evaluation and observation, empirically Xₒ=60 degrees can be used for both CSF_{source} and CSFₜₑₛₜ. The value of L in each CSF is set to the peak luminance of the corresponding input frame. For example, in case of a source frame with a peak luminance of 1000 nits and a test frame with a peak luminance of 600 nits, L=1000 for CSF_{source} and L=600 for CSFₜₑₛₜ. Therefore, the peak luminance of source and test frames are among the inputs of the algorithm. To ignore surrounding luminance, Lₛ=L may be set for both CSF_{source} and CSFₜₑₛₜ, and the factor f may be equal to 1 for both CSF's.

τₛ may therefore be defined as the reciprocal of the CSF as follows:

$${τ}_{s} ( f ) = \frac{\overline{μ}}{S ( u , L )} \qquad ( 6 )$$

where:
μ̅ is the mean signal intensity, and
S( . . . ) is the CSF.

This threshold value is calculated based on contrast sensitivity measurement assuming pure sinusoidal stimulus. To convert it to a signal strength threshold measured using the standard deviation of the signal, it is taken into account that signal amplitude scales with both contrast and mean signal intensity, and there is a \sqrt{2} factor between the amplitude and standard deviation of a sinusoidal signal. As a result, a threshold value defined on signal standard deviation can be computed as:

$${τ}_{s} ( f ) = \frac{\overline{μ}}{\sqrt{2} S ( u , L )} \qquad ( 7 )$$

Instead of defining just one t for both the original HDR frame 112 of the original HDR video 102 and the reduced HDR frame 114 of the test HDR video 106, two t may be used: τ_{source} for the original HDR frame 112 of the original HDR video 102 and τₜₑₛₜ for the reduced HDR frame 114 of the test HDR video 106. The rationale behind this distinction comes from the fact that the luminance and bit depth of the source frame are often different from the luminance and bit depth of the test frame.

Therefore, from equation (2) it can be seen that:

$${σ}^{′} = \frac{1}{\sqrt{2 π} {θ}_{s}} {\int }_{- ∞}^{σ} exp [ - \frac{{( x - {τ}_{σ} )}^{2}}{2 {θ}_{σ}^{2}} ] dx \qquad ( 8 )$$

where:
σ′ is the mapped version of σ and appears in the signal strength difference detector term (a) of equation (1).

In a naïve implementation for SDR, μ̅ may be equal to 128 (which is the mean of the dynamic range of 8 bits/pixel images). However, improved approaches for use with HDR in setting μ̅ for the for τ_{source} and τₜₑₛₜ may be defined to increase performance of the approach on HDR video assets.

A perceptual quantizer (PQ) refers to a transfer function that allows for HDR display. PQ is a non-linear transfer function based on the human visual perception of banding. An inverse of the PQ may be implemented as follows:

$${E}^{′} = {( \frac{{c}_{1} + {c}_{2} {Y}^{{m}_{1}}}{1 + {c}_{3} {Y}^{{m}_{1}}} )}^{{m}_{2}} , Y = \frac{{F}_{D}}{10000} \qquad ( 9 )$$

$${c}_{1} = \frac{3424}{4096} = {c}_{3} - {c}_{2} + 1 , {c}_{2} = \frac{2413}{4096} \times 32 , {c}_{3} = \frac{2392}{4096} \times 32$$

$${m}_{1} = \frac{2610}{16384} , {m}_{2} = \frac{2523}{4096} \times 128$$

where:
c₁, c₂, c₃, m₁, and m₂ are constants as defined above,
F_{D} is the luminance in nits, and
E′ is the resulting non-linear signal in the range [0, 1].

The non-linear signal value E′ may be mapped to a digital codeword as follows:

$$D = Round [ ( 2 \; 19 \times {E}^{′} + 16 ) \times {2}^{n - 8} ] \qquad ( 10 )$$

where:
D denotes the resulting digital codeword, and
n is the bit depth.
   The formula results in narrow range codewords, which is more common than the full range.

Combining the two formulas above, the inversePQ function may be defined, which receives the luminance F_{D} and the bit depth n as inputs and that outputs a narrow range codeword for that particular luminance and bit depth.

The μ̅ in both τ_{source} and τₜₑₛₜ may be defined as the inversePQ function with corresponding luminance and bit depth, resulting in the final form of τ_{source} and τₜₑₛₜ as follows:

$${τ}_{s o u r c e} = \frac{inversePQ ( {lum}_{s o u rce} , {bitdepth}_{s o u r c e} )}{\sqrt{2} S ( u , {L}_{s o u r c e} )} \qquad ( 11 )$$

$${τ}_{test} = \frac{i n v e r sePQ ( {lum}_{test} , {bitdepth}_{test} )}{\sqrt{2} S ( u , {L}_{test} )}$$

In one non-limiting example, the original HDR frame 112 is a 12 bits/pixel image and the reduced HDR frame 114 is a 10 bits/pixel image. Therefore, in some cases, bitdepth_{source}=12 and bitdepthₜₑₛₜ=10. For the lum_{source} and lumₜₑₛₜ values, it may be desirable for these values to be approximately equal to the mean luminance of the input source and test frames. Therefore, these may be set to the peak luminance of source and test frames divided by a factor of 10. For example, in case of a source frame with a peak luminance of 1000 nits and a test frame with a peak luminance of 600 nits, lum_{source}=100 and lumₜₑₛₜ=60.

The local structural fidelity measure may be applied to the original HDR frame 112 and the reduced HDR frame 114 using a sliding window that runs across the image space. This results in a per-scale structural fidelity map that reflects the variation of structural fidelity across space. The visibility of image details depends on the sampling density of the image, the distance between the image and the observer, the resolution of the display, and the perceptual capability of the observer's visual system. A single-scale method cannot capture such variations.

Returning to the spatial frequency for different scales, the structural fidelity measurement may be done for a plurality of different scales following the multiscale SSIM approach. A viewing distance of 32 cycles/degree may be assumed, which can represent signals up to 16 cycles/degree of resolution without aliasing, and thus 16 cycles/degree may be usable as the spatial frequency parameter when applying the CSF into the finest scale measurement, with subsequent finer scales of 8, 4, 2, 1 cycles/degree, respectively. In practice, however, these values can be too large. In the improved tone mapped video quality index, a spatial frequency of 8 cycles/degree is used for the first scale measurement, and the spatial frequency is divided by a factor of 2 for each subsequent scale measurement, resulting in a sequence of [8, 4, 2, 1, 0.5] cycles/degree of spatial frequency. The per-scale structural fidelity map is generated at each scale.

At each scale, the map is pooled by averaging to provide a single score:

$${S}_{l} = \frac{1}{{N}_{l}} {\sum }_{i = 1}^{{N}_{l}} {S}_{l o c a l} ( {x}_{i} , {y}_{i} ) \qquad ( 12 )$$

where:
xᵢ and yᵢ are the i^{th} patches in the original HDR frame 112 and the reduced HDR frame 114 being compared, respectively, and
Nₗ is the number of patches in the l^{th} scale.

The overall structural fidelity is calculated by combining scale level structural fidelity scores as shown:

$$S = {\prod }_{l = 1}^{L} {S}_{l}^{{β}_{l}} \qquad ( 13 )$$

where:
L is the total number of scales, and
βₗ is the weight assigned to the l^{th} scale.

There are several parameters in the implementation of the structural fidelity model that may be configured. First, when computing S_{local}, C₁=0.01 and C₂=10, the overall performance of the structural fidelity model is insensitive to these parameters within an order of magnitude. Second, to create the fidelity map at each scale, the same setting may be adopted as in the SSIM algorithm by employing a Gaussian sliding window of size 11×11 with standard deviation 1.5. When combining the measures across scales, constants may be set empirically to, for example, L=5 and {βl}={0.0448, 0.2856, 0.3001, 0.2363, 0.1333}. In order to assess the quality of color images, the images may be converted from red-green-blue (RGB) color space to Yxy space and then the structural fidelity measure may be applied on the Y component only.

FIG. 1C illustrates an example combination of the structural fidelity determination 108 discussed in FIGS. 1A-1B with a statistical naturalness determination 122. Aspects of FIG. 1C involving the determination of S, which may be implemented as described above.

As shown in FIG. 1C, the original HDR video 102 and the test HDR video 106 may further be applied to a statistical naturalness determination 122 block, the result of which is a score referred to herein as N. The outputs S and N are combined by a video quality index (VQI) determination 124 block, resulting in a tone mapped video quality index score 126, sometimes referred to herein as Q, indicative of the quality of the test HDR video 106 in view of the original HDR video 102 in terms of both structural fidelity and also in terms of statistical naturalness.

Regarding the statistical naturalness, a high quality test HDR video 106 frame should not only faithfully preserve the structural fidelity of the original HDR video 102, but also look natural. Nevertheless, naturalness is a subjective quantity that is difficult to define quantitatively. A large literature has been dedicated to the statistics of natural images which have important significance to both image processing applications and the understanding of biological vision. A study of naturalness in the context of subjective evaluation of tone mapped images was carried out in, which provided useful information regarding the correlations between image naturalness and different image attributes such as brightness, contrast, color reproduction, visibility and reproduction of details. The results showed that among all attributes being tested, brightness and contrast have more correlation with perceived naturalness. This motivates the statistical naturalness model to use these two attributes. This choice may be oversimplifying in defining the general concept of statistical image naturalness (and may not generalize to other image processing applications that uses the concept of naturalness), but it provides an ideal compromise between the simplicity of equation (1) and the capability of capturing the most important ingredients of naturalness that are related to the tone mapping evaluation, where brightness mapping is an inevitable issue in all tone mapping operations. It also allows the second term (b) to complement the structural fidelity measure described with respect to the first term (a) where brightness modeling and evaluation are missing.

Various approaches may be used for the determination of statistical naturalness. A complete example of an approach is provided herein, but it should be noted that this is merely an example and variation on the determination of statistical naturalness are contemplated.

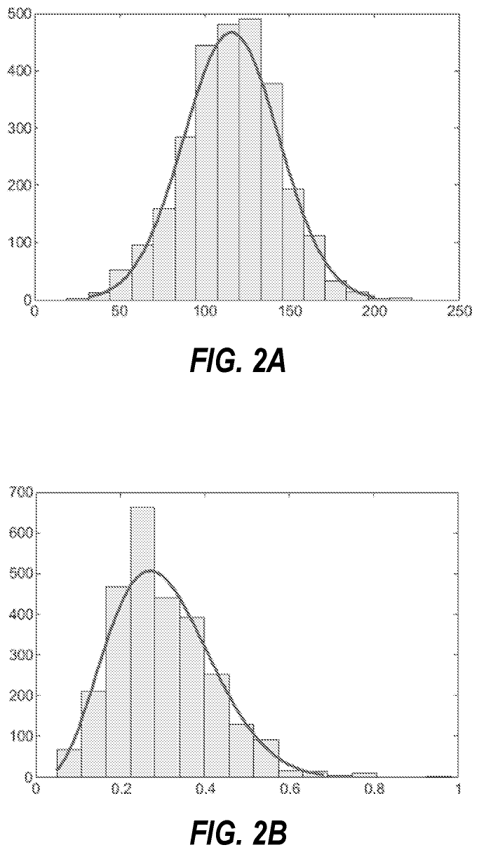

One statistical naturalness model is built upon statistics conducted on about 3,000 8 bits/pixel gray-scale images that represent many different types of natural scenes. FIGS. 2A-2B shows the histograms of the means and standard deviations of these images, which are useful measures that reflect the global intensity and contrast of images. These histograms can be well fitted using a Gaussian and a Beta probability density functions given by:

$${P}_{m} ( m ) = \frac{1}{\sqrt{2 π} {σ}_{m}} exp [ - \frac{m - {μ}_{? n}}{2 {σ}_{m}^{2}} ] \qquad ( 14 )$$

$$and$$

$${P}_{d} ( d ) = \frac{{( 1 - d )}^{{β}_{d} - 1} {d}^{{α}_{d} - 1}}{B ( {α}_{d} , {β}_{d} )} \qquad ( 15 )$$

where:
B(⋅,⋅) is the Beta function.
   The fitting curves are also shown in FIGS. 2A-2B, where the model parameters are estimated by regression, with values of μₘ=115.94 and σₘ=27.99, and α_{d}=4.4 and β_{d}=10.1.

Brightness and contrast may be considered to be largely independent quantities in terms of both natural image statistics and biological computation. As a result, their joint probability density function would be the product of the two. Therefore, the statistical naturalness measure may be defined as:

$$N = \frac{1}{K} {P}_{m} {P}_{d} \qquad ( 16 )$$

where
K is a normalization factor given by K=max{Pₘ,P_{d}}.
   This constrains the statistical naturalness measure to be bounded between 0 and 1.

Turning to the overall quality assessment model of equation (1), the structural fidelity measure S and the statistical naturalness measure N characterize different aspects of the quality of tone mapped images. They may be used individually or jointly as a vector valued measure. In many practical applications, however, users prefer a single score that indicates the overall quality of the image. Therefore these parameters should be combined in some manner. For IQA, various techniques have been used to combine image statistics and measures of structure and contrast, though in a different context. Here a three-parameter function is defined to scalarize the joint measure, resulting in the tone mapped video quality index:

$$Q = a {S}^{α} + ( 1 - a ) {N}^{β} \qquad ( 17 )$$

where:
0≤a≤1 adjusts the relative importance of the two components, and
α and β determine their sensitivities, respectively.
   Since both S and N are upper-bounded by 1, the overall quality measure is also upper-bounded by 1.

The parameters in equation (17) may be determined empirically. Finding the best parameters in (17) using subjective data is essentially a regression problem. The major difference from traditional regression problems is that relative ranking data is available between images only, but not quality scores associated with individual images. A learning method may be used where the parameters are learnt from an iterative method. At each iteration, one pair of images is randomly selected from one randomly selected data set. If the model generates objective scores that give the same order of the pair as the subjective rank order, then there is no change to the model parameters; otherwise, each parameter is updated towards the direction of correcting the model error by a small step. The iteration continues until convergence. Furthermore, to ensure the robustness of the approach, a leave-one-out cross validation procedure may be used, where the database (of n data sets) was divided into n−1 training sets and 1 testing set, and the same process was repeated 6 times, each with a different division between training and testing sets. Although different iterations may result in different sets of parameters, they are fairly close to each other and result in the same ranking orders for all the training and testing sets. In an example, a=0.8012, α=0.3046, and β=0.7088 may be used as the model parameters.

The tone mapped video quality index may now be used as an objective quality measure to compare tone-mapped images with different dynamic ranges. Example testing of the tone mapped video quality index may be performed using source original HDR video 102 from raw luma, blue projection, and red projection (YUV) frames (pixel format: yuv444p12le) decoded from HDR10+ content. The content in these examples had been mastered in 1000 nits. The test HDR video 106 may include raw YUV frames (pixel format: yuv420p10le) decoded from the same content, to a target peak luminance of 250, 500, and 1000 nits.

As noted above, the structural fidelity metric is a multi-scale metric. Thus, the structural fidelity metric is calculated for each scale and then an aggregation of scores is performed to generate a single final score. There are five scales in the example structural fidelity metric. The first scale is at the original resolution. Then the resolution is consecutively downsampled until the fifth scale is achieved.

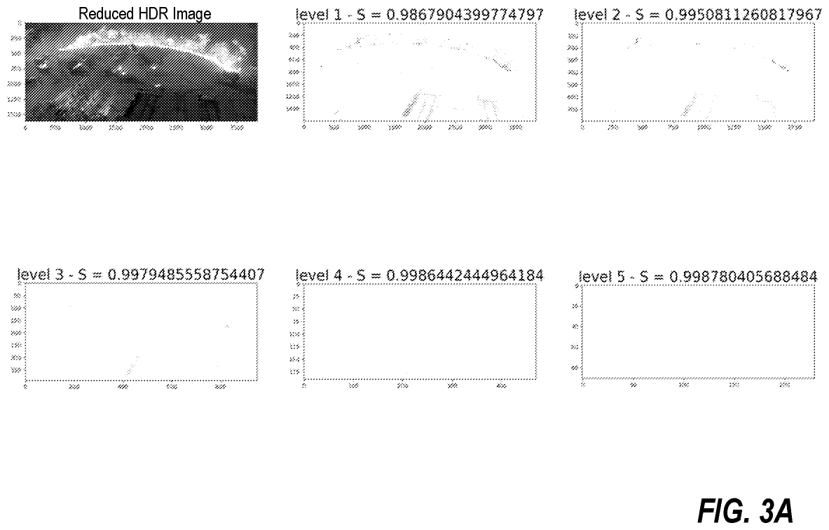

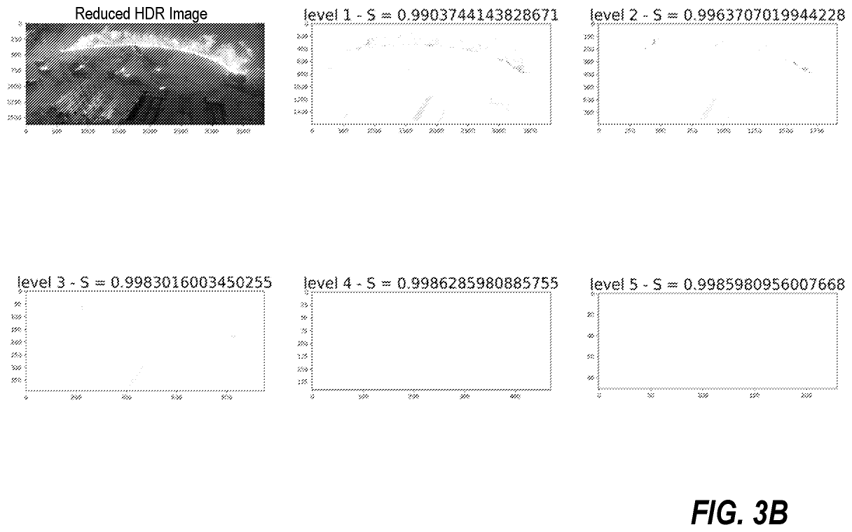

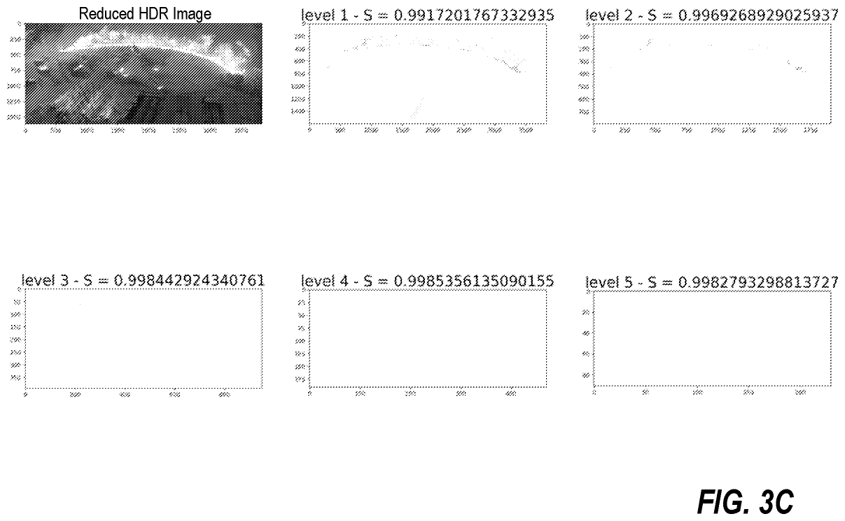

FIG. 3A illustrates an example of a first tone mapped image and a set of per-scale structural fidelity maps computed at 250 nits of test target luminance. FIG. 3B illustrates an example of the first tone mapped image and a set of per-scale structural fidelity maps computed at 500 nits of test target luminance. FIG. 3C illustrates an example of the first tone mapped image and a set of per-scale structural fidelity maps computed at 1000 nits of test target luminance.

The upper left image in each of FIGS. 3A-3C is the original HDR video 102. The remaining five images are the five per-scale structural fidelity maps in level order, of 16, 8, 4, 2, 1 cycles/degree, respectively. Each per-scale structural fidelity map is additionally shown with its respective score structural fidelity score S.

In FIG. 3A, the combined structural fidelity score S is ≈0.997, the statistical naturalness measure N is ≈9.080e-05, and the tone mapped video quality index is ≈0.801. In FIG. 3B, the combined structural fidelity score S is ≈0.998, the statistical naturalness measure N is ≈1.935e-07, and the tone mapped video quality index is ≈0.801. In FIG. 3C, the combined structural fidelity score S is ≈0.998, the statistical naturalness measure N is ≈2.499e-11, and the tone mapped video quality index is ≈0.801.

It can be seen in this first tone mapped image that in all cases of 250, 500, and 1000 nits test luminance, the structural fidelity score is high and the structural fidelity map indicates minimal to no loss of details and structures.

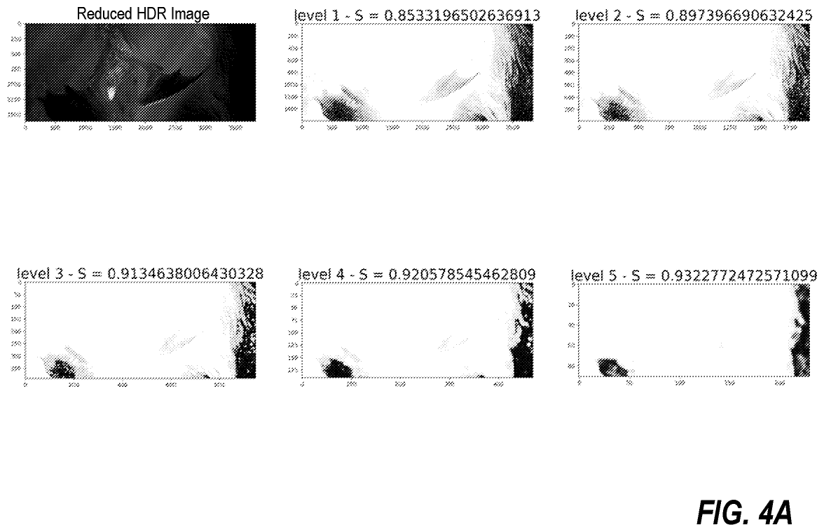

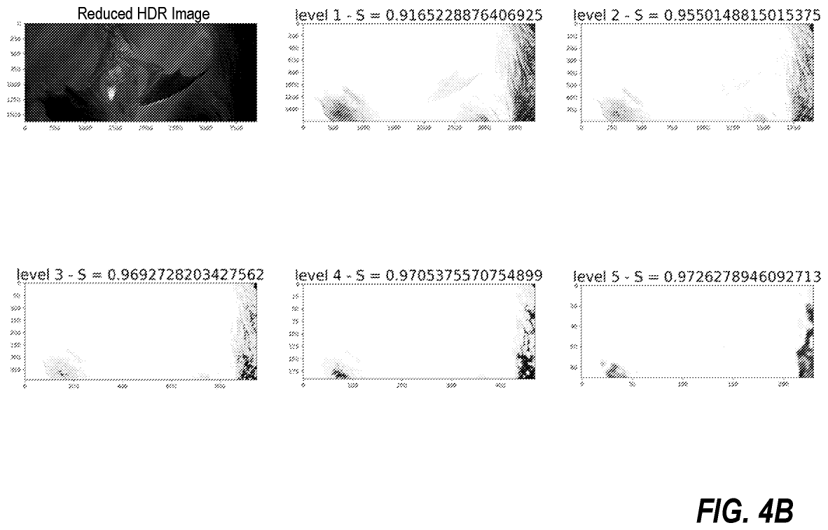

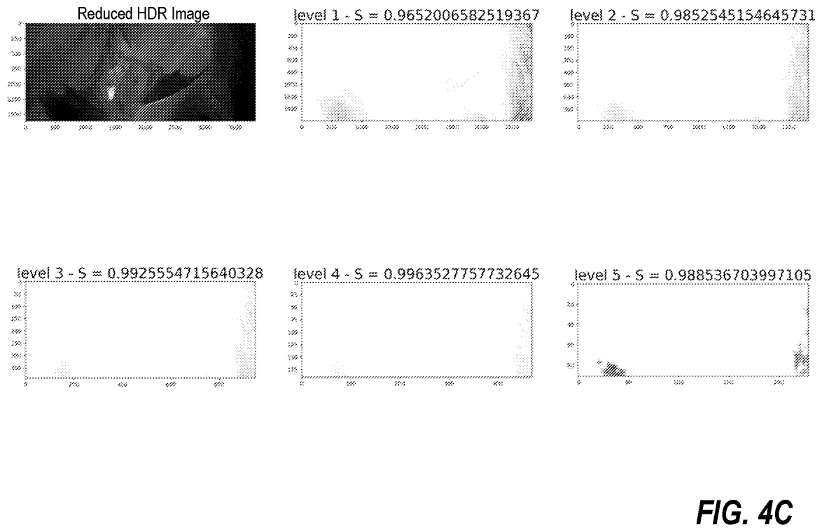

FIG. 4A illustrates an example of a second tone mapped image and a set of per-scale structural fidelity maps computed at 250 nits of test target luminance. FIG. 4B illustrates an example of the second tone mapped image and a set of per-scale structural fidelity maps computed at 500 nits of test target luminance. FIG. 4C illustrates an example of the second tone mapped image and a set of per-scale structural fidelity maps computed at 1000 nits of test target luminance.

The results for 250 and 500 nits test luminance were in line with our expectations and observations, as we observed the structural loss in black regions of the structural fidelity maps. In case of 1000 nits test luminance, it would be expected to have a clean white structural fidelity map and a structural fidelity score greater than 0.99, but some dark points can be seen in the structural fidelity map. It is possible that this occurred because the device being used for observations was incapable of generating luminance greater than 666 nits.

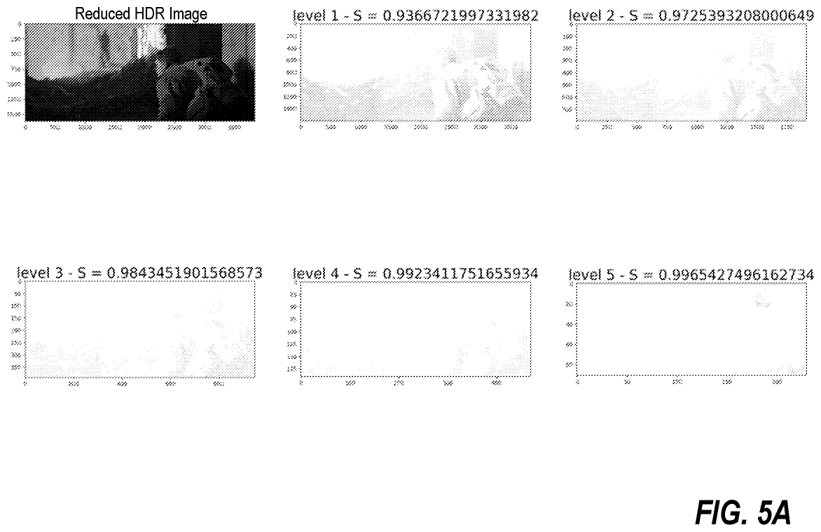

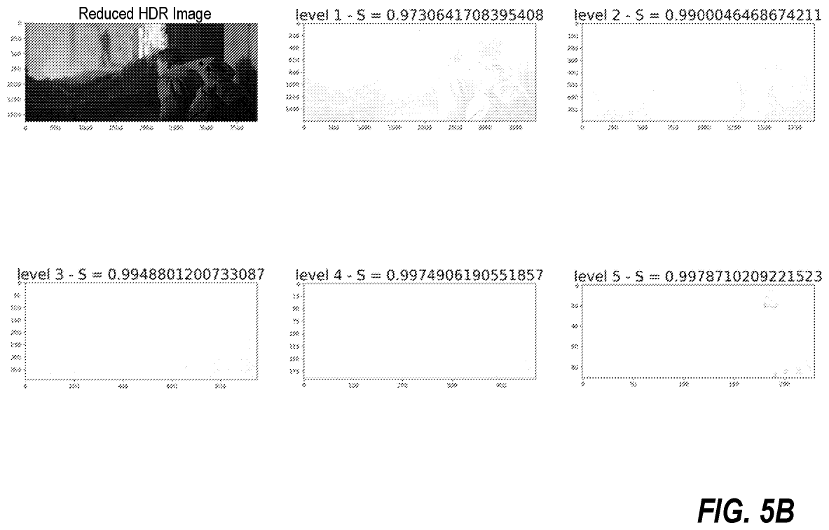

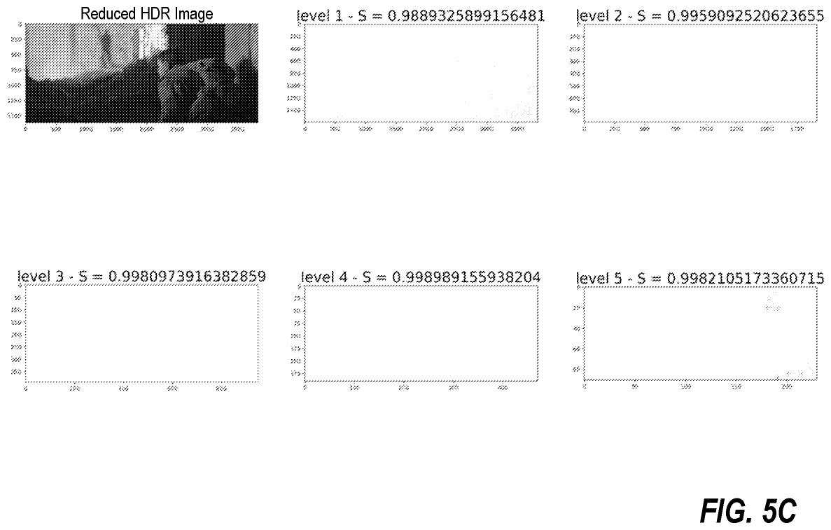

FIG. 5A illustrates an example of a third tone mapped image and a set of per-scale structural fidelity maps computed at 250 nits of test target luminance. FIG. 5B illustrates an example of the third tone mapped image and a set of per-scale structural fidelity maps computed at 500 nits of test target luminance. FIG. 5C illustrates an example of the third tone mapped image and a set of per-scale structural fidelity maps computed at 1000 nits of test target luminance. Again, the results are in line with observations. In this example, the frame is relatively dark itself, and only minimal structural loss is visible in any of three cases.

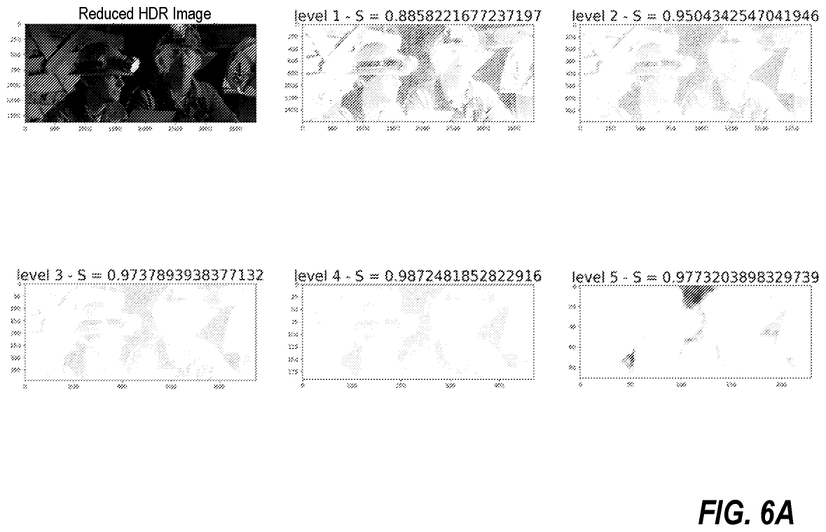

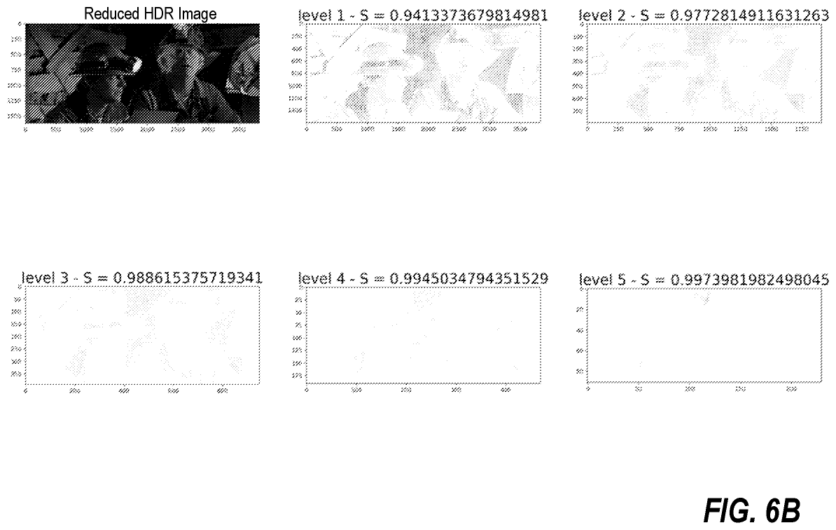

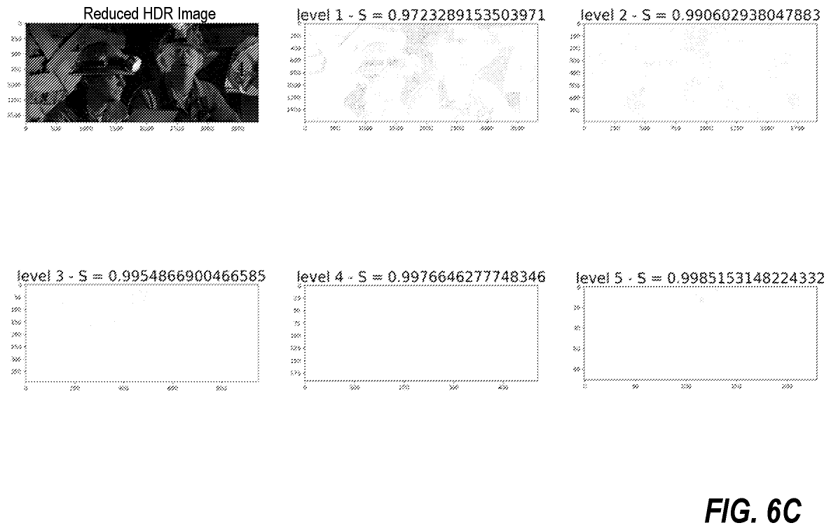

FIG. 6A illustrates an example of a fourth tone mapped image and a set of per-scale structural fidelity maps computed at 250 nits of test target luminance. FIG. 6B illustrates an example of the fourth tone mapped image and a set of per-scale structural fidelity maps computed at 500 nits of test target luminance. FIG. 6C illustrates an example of the fourth tone mapped image and a set of per-scale structural fidelity maps computed at 1000 nits of test target luminance. Again, the results are in line with observations.

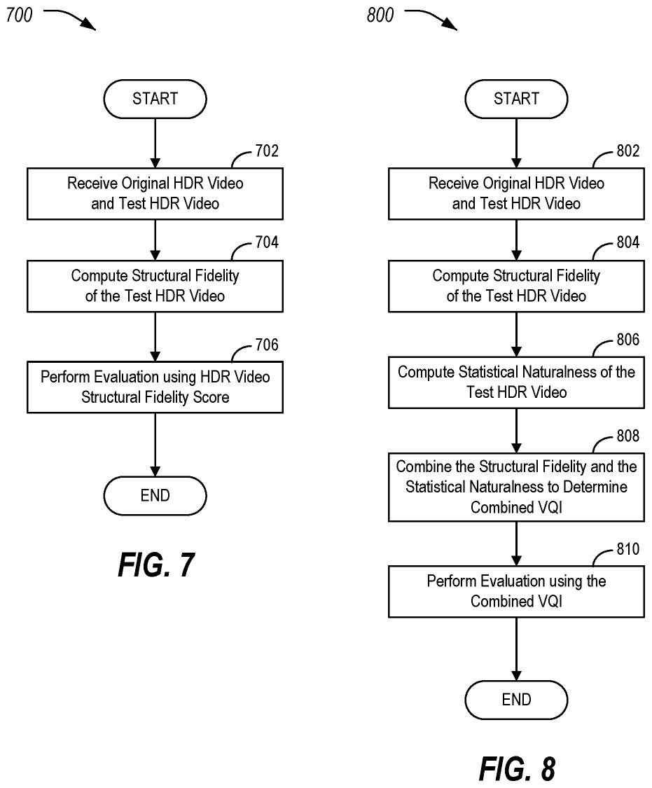

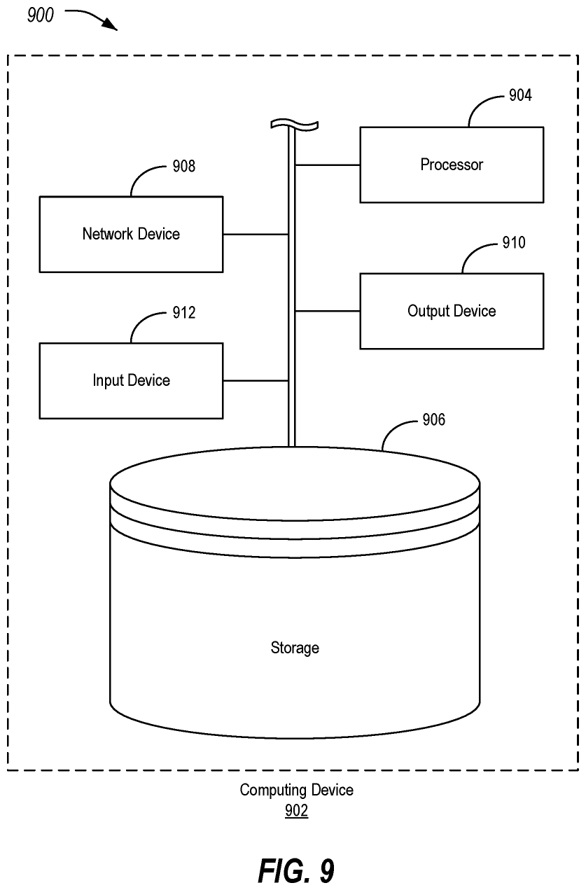

FIG. 7 illustrates an example process 700 for performing a structural fidelity analysis of reduced HDR video. In an example, the process 700 may be performed by one or more computing devices 902, an example of which is shown in FIG. 9.

At operation 702, the computing device 902 receives receiving an original HDR video 102 having a first range of intensity levels and a test HDR video 106 having a second range of intensity levels, the second range of intensity levels being less than the first range of intensity levels. In an example, the test HDR video 106 may be created from the original HDR video 102 using a TMO 104 to be evaluated by the tone mapped video quality index.

At operation 704, the computing device 902 computes structural fidelity of the test HDR video 106. In an example, the computing device 902 may determine a measure, S, of structural fidelity of the test HDR video 106 using a combination of a plurality of per-scale structural fidelity maps, the structural fidelity being computed using a CSF based on operation of the human visual system. In an example, the CSF may be the modified Barten's CSF discussed with respect to equation (4).

The computation of the structural fidelity may account for differences in luminance and bit depth of the original HDR video 102 by defining a source modulation threshold τ_{source} for the original HDR video 102 based on luminance and bit depth of the original HDR video 102 and the contrast sensitivity function, as shown in equation (11). The computation of the structural fidelity may account for differences in luminance and bit depth of the test HDR video 106 by defining a test modulation threshold τₜₑₛₜ based on luminance and bit depth of the test HDR video 106 and the contrast sensitivity function, also shown in equation (11). The standard deviation between the original HDR video 102 and the test HDR video 106 may be mapped using the source modulation threshold and the test modulation threshold, as shown in term (a) of equation (1). In an example, the inversePQ transfer function discussed with respect to equations (9) and (10) may be used to determine an output for scaling the CSF based on the luminance and the bit depth of the original HDR video 102 and the test HDR video 106.

In some examples, the computation at operation 704 may be made for a plurality of reduced HDR frames 114 of the test HDR video 106 vs corresponding original HDR frames 112 of the original HDR video 102, where the scores for each frame are averaged or otherwise combined to determine a HDR video structural fidelity score 110.

At operation 706, the computing device 902 uses the HDR video structural fidelity score 110 to evaluate the TMO 104. In an example, the tone mapped video quality index may be computed based on performing operation 704 on one or more frames of the output test HDR video 106 compared to the same frames of the original HDR video 102, as well as to compare the performance of different TMOs 104. In another example, the tone mapped video quality index may be computed based on one or more frames of the output test HDR video 106 vs the same original HDR video 102 and used to compare the performance of different parameters or settings of the same TMO 104. These approaches may allow an operator to identify the best TMO 104 and/or TMO 104 parameters to use when converting HDR video to HDR video of lower dynamic range.

In another example, when evaluating different TMOs 104 on different original HDR videos 102, it may be found that no single TMO 104 that produces the best results for all videos. Furthermore, within a single frame of video, the best TMO 104 may also vary when different regions in the image are under consideration. To take the advantages of multiple TMOs 104, image fusion techniques may be employed to combine multiple tone mapped images to generate a preferred overall image. After operation 706, the process 700 ends.

FIG. 8 illustrates an example process 800 for performing a combined structural fidelity and statistical naturalness analysis of reduced HDR video. In an example, as with the process 700 the process 800 may be performed by one or more computing devices 902.

At operation 802, as discussed with respect to operation 702 of the process 700, the computing device 902 receives receiving an original HDR video 102 having a first range of intensity levels and a test HDR video 106 having a second range of intensity levels, the second range of intensity levels being less than the first range of intensity levels. At operation 804, as discussed with respect to operation 704 of the process 700, the computing device 902 computes structural fidelity of the test HDR video 106.

At operation 806, the computing device 902 computes statistical naturalness of the test HDR video 106. In an example, the computing device 902 may determine a measure, N, of statistical naturalness of the test HDR video 106 using brightness and contrast, as those factors may show good correlation with perceived naturalness. Aspects of the computation of the statistical naturalness are shown with respect to equations (14), (15), and (16).

At operation 808, the computing device 902 combines the structural fidelity of the test HDR video 106 and the statistical naturalness of the test HDR video 106 to determine the tone mapped video quality index score 126. An example approach for the combination of the measure of structural fidelity S and the measure of statistical naturalness N to provide Q (the tone mapped video quality index), is shown in equation (17).

At operation 810, the computing device 902 the tone mapped video quality index score 126 to evaluate the TMO 104. Similar to as discussed at operation 706 of the process 700, the tone mapped video quality index may be used for evaluating different TMOs 104 and/or for evaluating performance of different parameters or settings of the same TMO 104. Also similar to as discussed with respect to the process 700, the analysis may be performed for a single frame or for multiple frames of the test HDR video 106 vs the original HDR video 102. After operation 810, the process 800 ends

FIG. 8 illustrates an example 900 of a computing device 902 for use in performing the operations discussed in detail herein. As shown, the computing device 902 includes a processor 904 that is operatively connected to a storage 906, a network device 908, an output device 910, and an input device 912. It should be noted that this is merely an example, and computing devices 902 with more, fewer, or different components may be used.

The processor 904 may include one or more integrated circuits that implement the functionality of a central processing unit (CPU) and/or graphics processing unit (GPU). In some examples, the processors 904 are a system on a chip (SoC) that integrates the functionality of the CPU and GPU. The SoC may optionally include other components such as, for example, the storage 906 and the network device 908 into a single integrated device. In other examples, the CPU and GPU are connected to each other via a peripheral connection device such as peripheral component interconnect (PCI) express or another suitable peripheral data connection. In one example, the CPU is a commercially available central processing device that implements an instruction set such as one of the x86, ARM, Power, or microprocessor without interlocked pipeline stage (MIPS) instruction set families.

Regardless of the specifics, during operation the processor 904 executes stored program instructions that are retrieved from the storage 906. The stored program instructions, accordingly, include software that controls the operation of the processors 904 to perform the operations described herein. The storage 906 may include both non-volatile memory and volatile memory devices. The non-volatile memory includes solid-state memories, such as not and (NAND) flash memory, magnetic and optical storage media, or any other suitable data storage device that retains data when the system is deactivated or loses electrical power. The volatile memory includes static and dynamic random-access memory (RAM) that stores program instructions and data during operation of the framework 100.

The GPU may include hardware and software for display of at least two-dimensional (2D) and optionally 3D graphics to the output device 910. The output device 910 may include a graphical or visual display device, such as an electronic display screen, projector, printer, or any other suitable device that reproduces a graphical display. As another example, the output device 910 may include an audio device, such as a loudspeaker or headphone. As yet a further example, the output device 910 may include a tactile device, such as a mechanically raiseable device that may, in an example, be configured to display braille or another physical output that may be touched to provide information to a user.

The input device 912 may include any of various devices that enable the computing device 902 to receive control input from users. Examples of suitable input devices that receive human interface inputs may include keyboards, mice, trackballs, touchscreens, voice input devices, graphics tablets, and the like.

The network devices 908 may each include any of various devices that enable the devices to send and/or receive data from external devices over networks. Examples of suitable network devices 908 include an Ethernet interface, a Wi-Fi transceiver, a cellular transceiver, or a BLUETOOTH or BLUETOOTH low energy (BLE) transceiver, ultra-wideband (UWB) transceiver, or other network adapter or peripheral interconnection device that receives data from another computer or external data storage device, which can be useful for receiving large sets of data in an efficient manner.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as read-only memory (ROM) devices and information alterably stored on writeable storage media such as floppy disks, magnetic tapes, compact discs (CDs), RAM devices, and other magnetic and optical media. The processes, methods, or algorithms can also be implemented in a software executable object. Alternatively, the processes, methods, or algorithms can be embodied in whole or in part using suitable hardware components, such as application specific integrated circuit (ASIC), field-programmable gate array (FPGA), state machines, controllers or other hardware components or devices, or a combination of hardware, software and firmware components.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to strength, durability, life cycle, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

1.-39. (canceled)

40. A method of selecting a tone mapping operation (TMO) for converting high dynamic range (HDR) video, comprising:
applying a tone mapping operation to an original HDR video to generate a test HDR video having a reduced dynamic range;
computing a video structural fidelity measure for the test HDR video and the original HDR video using a contrast sensitivity function to determine signal strength for a test frame of the test HDR video and signal strength of a corresponding original frame of the original HDR video, wherein computing the video structural fidelity measure expresses a signal strength difference between a test frame signal strength of each test frame and an original frame signal strength of the corresponding original frame, wherein the contrast sensitivity function is scaled separately for the original HDR video and the test HDR video based on a first luminance range and bit depth of the original HDR video and a second luminance range and bit depth of the test HDR video, the first luminance range being different from the second luminance range; and
using the video structural fidelity measure to compute a video structural fidelity score and to select the tone mapping operation for conversion of the original HDR video based on the video structural fidelity score.

41. The method of claim 40, wherein the video structural fidelity measure is configured for the test frame and the corresponding original frame using a psychovisual model of a human visual system to determine the signal strength of each test frame to be significant or insignificant and to determine the signal strength of each corresponding original frame to be significant or insignificant.

42. The method of claim 41, wherein the signal strength significance and the signal strength insignificance of the original frame signal strength is based on using a modified standard deviation of the original frame signal strength determined by a non-linear mapping of a standard deviation of the original frame signal strength using the psychovisual model and the signal strength significance and the signal strength insignificance of the test frame signal strength is based on using a modified standard deviation of the test frame signal strength determined by a non-linear mapping of a standard deviation of the test frame signal strength using the psychovisual model.

43. The method of claim 40, where computing the video structural fidelity measure uses a multi-scale approach, the multi-scale approach having multiple scale levels where a per scale structural fidelity map is created at each scale level, wherein the per scale structural fidelity maps comprise per-scale structural fidelity scores that are combined to produce an overall fidelity measure score for the scale level.

44. The method of claim 40, wherein the test frame is a portion of the test frame, and the corresponding original frame is a portion of the corresponding original frame that corresponds with the portion of the test frame.

45. The method of claim 43, further comprising combining the overall structural fidelity measure of each scale level to produce the HDR video structural fidelity score of the test HDR video.

46. The method of claim 40, further comprising:
computing a measure of statistical naturalness of the test HDR video; and
combining the video structural fidelity measure and the measure of statistical naturalness to determine a tone mapped video quality index for the test HDR video.

47. The method of claim 46, further comprising:
generating the test HDR video from the original HDR video using a TMO; and
using the tone mapped video quality index to evaluate performance of the TMO.

48. The method of claim 46, wherein the statistical naturalness uses brightness and contrast as factors that correlate with perceived naturalness, and the video structural fidelity measure is computed without regard to brightness and contrast.

49. The method of claim 40, further comprising accounting for differences in luminance and bit depth of the original HDR video and the test HDR video by:
defining a source modulation threshold for one or more original frames of the original HDR video based on luminance and bit depth of the one or more original frames of the original HDR video and the contrast sensitivity function;
defining a test modulation threshold for one or more test frames of the test HDR video based on luminance and bit depth of the one or more test frames of the test HDR video and the contrast sensitivity function; and
mapping standard deviation between the one or more original frames of the original HDR video and the corresponding one or more test frames of the test HDR video using the source modulation threshold and the test modulation threshold.

50. The method of claim 49, further comprising:
accounting for the luminance and the bit depth of the one or more original frames of the original HDR video using an inverse perceptual quantizer (PQ) transfer function that defines an output for scaling the contrast sensitivity function based on the luminance and the bit depth of the original HDR video; and
accounting for the luminance and the bit depth of the one or more test frames of the test HDR video using the inverse perceptual quantizer (PQ) transfer function based on the luminance and the bit depth of the test HDR video.

51. The method of claim 40, where the test HDR video having the reduced dynamic range is a standard dynamic range (SDR) video.

52. A system for selecting a tone mapping operation (TMO) for converting high dynamic range (HDR) video, comprising:
one or more computing devices, programmed to:
apply a tone mapping operation to an original HDR video to generate a test HDR video having a reduced dynamic range;
compute a video structural fidelity measure for the test HDR video and the original HDR video using a contrast sensitivity function to determine signal strength for a test frame of the test HDR video and signal strength of a corresponding original frame of the original HDR video, wherein computing the video structural fidelity measure expresses a signal strength difference between a test frame signal strength of each test frame and an original frame signal strength of the corresponding original frame, wherein the contrast sensitivity function is scaled separately for the original HDR video and the test HDR video based on a first luminance range and bit depth of the original HDR video and a second luminance range and bit depth of the test HDR video, the first luminance range being different from the second luminance range; and
using the video structural fidelity measure to compute a video structural fidelity score and to select the tone mapping operation for conversion of the original HDR video based on the video structural fidelity score.

53. The system of claim 52, wherein the video structural fidelity measure is configured for the test frame and the corresponding original frame using a psychovisual model of a human visual system to determine the signal strength of each test frame to be significant or insignificant and to determine the signal strength of each corresponding original frame to be significant or insignificant.

54. The system of claim 53, wherein the signal strength significance and the signal strength insignificance of the original frame signal strength is based on using a modified standard deviation of the original frame signal strength determined by a non-linear mapping of a standard deviation of the original frame signal strength using the psychovisual model and the signal strength significance and the signal strength insignificance of the test frame signal strength is based on using a modified standard deviation of the test frame signal strength determined by a non-linear mapping of a standard deviation of the test frame signal strength using the psychovisual model.

55. The system of claim 52, where computing the video structural fidelity measure uses a multi-scale approach, the multi-scale approach having multiple scale levels where a per scale structural fidelity map is created at each scale level, wherein the per scale structural fidelity maps comprise per-scale structural fidelity scores that are combined to produce an overall fidelity measure score for the scale level.

56. The system of claim 55, further comprising combining the overall structural fidelity measure of each scale level to produce the HDR video structural fidelity score of the test HDR video.

57. The system of claim 52, wherein the test frame is a portion of the test frame, and the corresponding original frame is a portion of the corresponding original frame that corresponds with the portion of the test frame.

58. The system of claim 52, wherein the one or more computing devices are further programmed to:
compute a measure of statistical naturalness of the test HDR video; and
combine the video structural fidelity measure and the measure of statistical naturalness to determine a tone mapped video quality index for the test HDR video.

59. The system of claim 58, wherein the one or more computing devices are further programmed to:
generate the test HDR video from the original HDR video using a TMO; and
use the tone mapped video quality index to evaluate performance of the TMO.

60. The system of claim 58, wherein the statistical naturalness uses brightness and contrast as factors that correlate with perceived naturalness, and the video structural fidelity measure is computed without regard to brightness and contrast.

61. The system of claim 52, wherein the one or more computing devices are further programmed to account for differences in luminance and bit depth of the original HDR video and the test HDR video by:
defining a source modulation threshold for one or more original frames of the original HDR video based on luminance and bit depth of the one or more original frames of the original HDR video and the contrast sensitivity function;
defining a test modulation threshold for one or more test frames of the test HDR video based on luminance and bit depth of the one or more test frames of the test HDR video and the contrast sensitivity function; and
mapping standard deviation between the one or more original frames of the original HDR video and the corresponding one or more test frames of the test HDR video using the source modulation threshold and the test modulation threshold.

62. The system of claim 61, wherein the one or more computing devices are further programmed to:
account for the luminance and the bit depth of the one or more original frames of the original HDR video using an inverse perceptual quantizer (PQ) transfer function that defines an output for scaling the contrast sensitivity function based on the luminance and the bit depth of the original HDR video; and
account for the luminance and the bit depth of the one or more test frames of the test HDR video using the inverse perceptual quantizer (PQ) transfer function based on the luminance and the bit depth of the test HDR video.

63. The system of claim 52, where the test HDR video having the reduced dynamic range is a standard dynamic range (SDR) video.

64. A non-transitory computer-readable medium comprising instructions for selecting a tone mapping operation (TMO) for converting high dynamic range (HDR) video that, when executed by one or more computing devices, cause the one or more computing devices to perform operations including to:
apply a tone mapping operation to an original HDR video to generate a test HDR video having a reduced dynamic range;
compute a video structural fidelity measure for the test HDR video and the original HDR video using a contrast sensitivity function to determine signal strength for a test frame of the test HDR video and signal strength of a corresponding original frame of the original HDR video, wherein computing the video structural fidelity measure expresses a signal strength difference between a test frame signal strength of a test frame and an original frame signal strength of the corresponding original frame, wherein the contrast sensitivity function is scaled separately for the original HDR video and the test HDR video based on a first luminance range and bit depth of the original HDR video and a second luminance range and bit depth of the test HDR video, the first luminance range being different from the second luminance range; and
using the video structural fidelity measure to compute a video structural fidelity score and to select the tone mapping operation for conversion of the original HDR video based on the video structural fidelity score.

65. The non-transitory computer-readable medium of claim 64, wherein the video structural fidelity measure is configured for the test frame and the corresponding original frame using a psychovisual model of a human visual system to determine the signal of each test frame to be significant or insignificant and to determine the signal strength of each corresponding original frame to be significant or insignificant.

66. The non-transitory computer-readable medium of claim 65, wherein the signal strength significance and the signal strength insignificance of the original frame signal strength is based on using a modified standard deviation of the original frame signal strength determined by a non-linear mapping of a standard deviation of the original frame signal strength using the psychovisual model and the signal strength significance and the signal strength insignificance of the test frame signal strength is based on using a modified standard deviation of the test frame signal strength determined by a non-linear mapping of a standard deviation of the test frame signal strength using the psychovisual model.

67. The non-transitory computer-readable medium of claim 64, where computing the video structural fidelity measure uses a multi-scale approach, the multi-scale approach having multiple scale levels where a per scale structural fidelity map is created at each scale level, wherein the per scale structural fidelity maps comprise per-scale structural fidelity scores that are combined to produce an overall fidelity measure score for the scale level.

68. The non-transitory computer-readable medium of claim 67, further comprising combining the overall structural fidelity measure of each scale level to produce the HDR video structural fidelity score of the test HDR video.

69. The non-transitory computer-readable medium of claim 64, wherein the test frame is a portion of the test frame, and the corresponding original frame is a portion of the corresponding original frame that corresponds with the portion of the test frame.

70. The non-transitory computer-readable medium of claim 64, wherein the one or more computing devices are further programmed to:
compute a measure of statistical naturalness of the test HDR video; and
combine the video structural fidelity measure and the measure of statistical naturalness to determine a tone mapped video quality index for the test HDR video.

71. The non-transitory computer-readable medium of claim 70, wherein the one or more computing devices are further programmed to:
generate the test HDR video from the original HDR video using a TMO; and
use the tone mapped video quality index to evaluate performance of the TMO.

72. The non-transitory computer-readable medium of claim 70, wherein the statistical naturalness uses brightness and contrast as factors that correlate with perceived naturalness, and the video structural fidelity measure is computed without regard to brightness and contrast.

73. The non-transitory computer-readable medium of claim 64, wherein the one or more computing devices are further programmed to account for differences in luminance and bit depth of the original HDR video and the test HDR video by:
defining a source modulation threshold for one or more original frames of the original HDR video based on luminance and bit depth of the one or more original frames of the original HDR video and the contrast sensitivity function;
defining a test modulation threshold for one or more test frames of the test HDR video based on luminance and bit depth of the one or more test frames of the test HDR video and the contrast sensitivity function; and
mapping standard deviation between the one or more original frames of the original HDR video and the corresponding one or more test frames of the test HDR video using the source modulation threshold and the test modulation threshold.

74. The non-transitory computer-readable medium of claim 73, wherein the one or more computing devices are further programmed to:
account for the luminance and the bit depth of the one or more original frames of the original HDR video using an inverse perceptual quantizer (PQ) transfer function that defines an output for scaling the contrast sensitivity function based on the luminance and the bit depth of the original HDR video; and
account for the luminance and the bit depth of the one or more test frames of the test HDR video using the inverse perceptual quantizer (PQ) transfer function based on the luminance and the bit depth of the test HDR video.

75. The non-transitory computer-readable medium of claim 64, where the test HDR video having the reduced dynamic range is a standard dynamic range (SDR) video.
